(19) United States
(12) Patent Application Publication
(10) Pub. No.: US 2014/0222995 A1
(43) Pub. Date: Aug. 7, 2014

(54) Methods and System for Monitoring Computer Users

(71) Applicants: Anshuman Razden, Phoenix, AZ (US); John Femiani, Gilbert, AZ (US)

(72) Inventors: Anshuman Razden, Phoenix, AZ (US); John Femiani, Gilbert, AZ (US)

(21) Appl. No.: 13/762,306

(22) Filed: Feb. 7, 2013

(51) Int. Cl. H04L 12/26

(52) U.S. Cl. CPC H04L 43/10
USPC 709/224

(57) ABSTRACT

A method and system are provided for monitoring an online activity to be performed by a user of a user computer. A trigger program runs on the user computer to detect possible violations by the user of predefined rules associated with the online activity. The trigger program is configured to analyze multiple streams of data collected by the user computer during the activity. The analyzed data is automatically annotated to assist in determine whether a violation of the predefined rules occurred. The analyzed data is stored for reviewed after the activity. Each trigger program can be activated in response to at least one of: video information about the activity, facial recognition information about the user, audio information about the activity, keystroke information relating to the user computer and the browsing history of the user computer during the activity.

### RELATED APPLICATION

This application claims the benefit of U.S. Provisional Application No. 61/596,001, filed Feb. 7, 2012 and titled “Methods, Systems and Media for Monitoring Computer Users,” which is incorporated herein by reference.

### COPYRIGHT NOTIFICATION

Portions of this patent application include materials that are subject to copyright protection. The copyright owner has no objection to the facsimile reproduction by anyone of the patent document itself, or of the patent application as it appears in the files of the United States Patent and Trademark Office, but otherwise reserves all copyright rights whatsoever in such included copyrighted materials.

### BACKGROUND

This invention relates generally to methods and systems for monitoring online activities. More specifically, it relates to a method and system for auditing an online examination attempt by a student, wherein the method and system can detect, prioritize, and record incidents that occur during the examination attempt (which incidents include selected data associated with the examination attempt) and can allow the auditor to efficiently review the recorded incidents at a later time.

As computers are used more and more in different parts of society to replace activities that previously were performed in-person, there is an increasing need to monitor computer users. For example, computer-based education is become increasingly popular and thus there is an increasing need to be able to determine if a user taking an examination on a computer is cheating on the examination. Previous methods and systems for doing this have significant drawbacks in that they require large amounts of resources in the form of bandwidth, data storage and man-hours to record, store and review information about the online activity.

It is an object of the present invention, therefore, to provide a system and method that provides for the efficient recording, storage and review of online activities such as online examinations taken by students.

It is another object of the invention to provide such a system and method that can be used to automatically analyze, prioritize and store data from multiple data streams captured during such an online activity without having to store all of the data from the data streams.

It is yet another object of the invention to provide a system and method that can allow for the efficient review of data from an online activity and to allow for such review at a time after the online activity has been completed.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY

To achieve the foregoing objects, and in accordance with the purposes of the invention as embodied and broadly described in this document, there is provided a method and system for monitoring an online activity to be performed by a user of a user computer. The method can include the steps of: using a trigger program running on the user computer to detect possible violations by the user of predefined rules associated with the online activity, automatically annotating the analyzed data to assist in determining whether a violation of the predefined rules occurred, and storing on another computer a portion of the data collected by the user computer during the activity. The trigger program is configured to analyze one or more streams of data collected by the user computer during the activity. The stored data can be reviewed after the activity to determine whether a violation of the predefined rules occurred during the activity. The trigger program can be activated in response to at least one of: video information about the activity, facial recognition information about the user, audio information about the activity, keystroke information relating to the user computer, clipboard data and the browsing history of the user computer during the activity. The method can include performing a check of the user computer configuration before the online activity begins. Automatic prioritization of the analyzed data can occur before or after the storage of the collected data.

According to one method, the online activity can include taking an online examination and the data streams can be collected by the student computer during the examination. The stored data can be reviewed after the examination to determine whether the student cheated on the examination.

A system for monitoring an online examination to be attempted by a student includes a storage medium for storing data associated with an examination attempt. The stored data is collected from a plurality of data streams using a trigger program running on a student computer for detecting possible violations by the student of predefined rules associated with the examination attempt. A proctor computer is operative with the storage medium for presenting the stored data for review after the examination attempt for determining whether the student violated any of the predefined rules during the examination attempt. The stored data includes a portion of the data collected from the plurality of data streams. The trigger program is configured to analyze the plurality of data streams during the examination attempt and to automatically identify one or more positions of the data as incidents to assist in determining whether the student violated any of the predefined rules during the examination attempt. For example, the trigger program can be configured to assist in determining whether the student cheated during the examination attempt.

In one embodiment, the plurality of data streams include at least one of a video clip, a screen capture, an audio clip, keystroke data, clipboard data and browsing history information captured by the user computer. The trigger program can be activated in response to at least one of: video information about the examination attempt, facial recognition information about the student, audio information about the examination attempt, keystroke or clipboard information relating to the examination attempt and the browsing history of the student during the examination attempt.

### BRIEF DESCRIPTION OF THE DRAWINGS

FIG. 1 is a block diagram of one embodiment of a computer system and network system suitable for practicing the present invention.

FIG. 2 is a flow diagram of an exemplary process for monitoring an activity by a computer user in accordance with some embodiments of the invention.

FIG. 3A shows an example of user interface for a proctor in accordance with some embodiments of the invention.

FIGS. 3B-3G illustrate an example of the operation of various aspects of the proctor interface of FIG. 3A.

FIGS. 4A-4B show an example of a user interface for a student in accordance with some embodiments of the invention.

FIGS. 5A-5B illustrate an example of the operation of the student interface of FIG. 4A in creating a student profile, including a video identification.

FIGS. 6A-6B illustrate an example of the operation of the student interface of FIG. 4A in selecting an examination to be taken online.

FIG. 7 shows an exemplary display presented by the student interface of FIG. 4A for starting an examination.

FIGS. 8A-8B show examples of a student's computer screen displayed during an examination taken according to one embodiment of the invention

FIG. 9 shows an example main screen display of an interface that can be used by an administrator for configuring courses, examinations and triggers according to some embodiments and methods of the invention.

FIG. 10 shows an exemplary screen display of the administrator interface of FIG. 9 that can be used to search and add course information.

FIG. 11 shows an exemplary screen display of the administrator interface of FIG. 9 that can be used for configuring examination information.

FIG. 12 shows an exemplary screen display of the administrator interface of FIG. 9 that can be used to add and configure triggers.

FIGS. 13A-13C illustrate examples of reports that can be generated using one embodiment of an administrator client program according to the invention.

### DESCRIPTION

Reference will now be made in more detail to presently preferred embodiments and methods of the invention, as illustrated in the accompanying drawings. While the invention is described more fully with reference to these examples and drawings, the invention in its broader aspects is not limited to the specific details, representative devices, and illustrative examples shown and described. Rather, the description which follows is to be understood as a broad, teaching disclosure directed to persons of ordinary skill in the appropriate arts, and not as limiting upon the invention; the description is intended to cover alternatives, modifications, and equivalents as may be included within the spirit and scope of the invention as defined by the appended claims.

The present invention enables the monitoring of computer-user activities carried out by a computer user during a time at which the user's actions and/or immediate environment may be restricted. Such monitoring can include, for example, virtual attendance monitoring for academic e-learning activities including taking an examination, watching a lecture, participating in an interactive lesson, etc., and monitoring exams taken at remote locations to prevent cheating. The action and environment restrictions can include, for example, requiring a user to be attentive to a computer screen during a presentation or training demonstration, requiring a user to be silent during an examination, etc.

With some embodiments and methods of the invention, a proctor can monitor a student's physical environment during an exam, either to provide an audit trail when an instructor suspects cheating, or to reduce the amount of effort required to remotely proctor the exam. Triggers can be implemented in software programs that run on the student's computer in order to try to detect potential violations, called incidents. Incidents are reported to a proctoring server during the incident. Incident data (which can include, for example, video, screen shots, and audio) can be uploaded to the server at the end of the exam. Triggers can be configured via an easy-to-use proctor or instructor interface. The data is then available via the proctor/instructor interface for review at a later date. Some examples of such triggers include absence, interactive, noise, manual, and screen-capture triggers.

Manual triggers and the interactive triggers can be configured to create an incident at predefined times. An interactive trigger prompts the user to answer a question or press a button within a certain amount of time in order to suppress the incident. The manual trigger creates an incident at the specified times.

An audio trigger monitors the user computer's microphone to detect noise in the environment. The trigger can create an incident whenever the volume exceeds allowable background noise for an exam, and lasts longer than a typical keyboard click.

An absent trigger can use a face tracking algorithm to count the number of faces visible from the webcam of the user's computer. Whenever the number of faces is not one for more than a minimum amount of time, it can create an incident. In some embodiments, an incident is not created if the user looks down for a second, or if the user's face is temporarily occluded, but an incident is created if someone stands behind the user or the user leaves the computer, e.g. to go to the bathroom.

A screen capture trigger can create an incident whenever the user computer's foreground window title changes. The user can switch tabs in a browser, open a word processor, etc., but each time the user changes tabs or programs, an incident is created. The incident can send screen captures that are initiated when the active window changes and ends at a specified time elapse.

With some embodiments and methods, the invention can be used to create and review audit-trails for computer-user activities. An audit trail for an attempt at a computer-user activity can log incidents, wherein each incident can occur when one or more condition(s) activate a trigger. For example, an incident can be a detected change in the computer's environment that may (or may not) indicate an invalidating event, such as a student leaving the computer, opening a browser window, asking another student for help, and/or taking any other unauthorized action. An audit trail can include video evidence, photographic evidence, auditory evidence, screen capture evidence, textual evidence, and/or any other suitable evidence of changes in the state of a computer's environment in some embodiments. This evidence can be stored in a secure manner.

Some embodiments and methods of the invention can automatically tag and prioritize evidence, and provide a tool to support a streamlined hierarchical reviewing process so that evidence from the audit trail can be vetted before a decision is made regarding whether an activity is valid or suspect (invalid). Such vetting and decision making can be performed by any suitable party, such as a proctor, an instructor, a professor, a teaching assistant, etc. at any suitable time. Information can be cached and saved so that certain attempts (e.g., particularly suspicious attempts) can be reviewed at a later point in time.

The methods and embodiments of the present invention can be used with other mechanisms for delivering content (such as examinations or lecture videos), for “locking-down” features to prevent users from accessing restricted software such as chat programs, internet browsers, etc., and/or for performing any other suitable function.

### Triggers and Incidents

As mentioned above, one or more triggers can be used to create an incident about which content (such as video, audio, data, etc.) is recorded and/or logged. Such triggers can monitor a user's environment for a specific type of cue in order to create an incident. Any suitable number of incidents may be created and multiple incidents can occur simultaneously.

Any suitable triggers can be used. For example, triggers can include time-based triggers, user-data-based triggers, content-based triggers, sensor-based triggers, manual triggers (e.g., manually activated by a proctor or instructor watching a user live), user-proximity triggers (e.g., based on proximity of students to each other), and/or any other suitable triggers. Triggers can cause suitable actions to be taken during an incident. For example, in some embodiments, passive actions such as collecting content, logging content, recording content, etc. can be performed. As another example, interactive actions, such as asking a user to take some action(s) or to allow some actions to be taken, can be performed. As another example, a time-based trigger at the beginning of an examination can cause the first few minutes of an examination to be recorded. As yet another example, a time-based trigger at the end of an examination can cause the final moments of an examination to be recorded. As still another example, a user-data-based trigger can create incidents that flag attempts corresponding to certain users (e.g., students), such as those who have been suspected of or caught cheating in the past.

### Time-Based Trigger Examples

By way of example, a time-based trigger can ask an examination taker to re-authenticate himself or herself at any suitable point(s) in time (e.g., one or more random and/or scheduled points in time) during an examination. The examination taker can be asked to show his or her ear, hold up a certain number of fingers, answer a question (e.g., which can be specified by the examination builder), and/or perform any other suitable action(s). The examination taker may then have a limited amount of time to perform the required actions or the examination will be flagged. This can be used, for example, to prevent a student from cheating by looping a prerecorded video. In some embodiments, such a re-authentication can additionally or alternatively be required based on any other suitable trigger or type of trigger (e.g., when an examination taker goes out of frame). As still another example, a time-based trigger can create an incident if a user does not press any keys or move a mouse for a given period of time. In some embodiments, a time-based trigger can cause a video of the user to be recorded at certain times, at random times, and any suitable number of times.

### Content-Based Trigger Examples

By way of example, a content-based trigger can be activated when a detected audio volume for an examination-taker's environment changes, when speech, voices, mobile phone ringing, mobile phone vibrations, music, television, etc. is detected in audio, when keystroke sounds are detected that do not match keystrokes that are part of the attempt, etc. As another example, a content-based trigger can detect when a particular pattern of key-presses occurs. As still another example, a content-based trigger can detect when a title of the top-most (or focused) window changes or matches a pattern. As still another example, a content-based trigger can detect when a process name or an application running on the student's computer matches a pattern.

Content-based triggers can be activated based on video information. For example, a content-based trigger can be activated when an examination taker's head cannot be identified in video, and, in response thereto, video from a point before the examination taker's head could not be identified to a point after the examination taker's head once again could be identified can be recorded and the corresponding portion of an examination flagged.

Content-based triggers can be activated based on authentication, such as voice authentication or video authentication or recognition or movement detection. For example, a content-based trigger can be activated when face authentication technology fails to verify the identity of an examination taker a certain number of times, and, in response thereto, video from a point before the examination taker could not be authenticated to a point after the examination taker once again could be authenticated can be recorded and the corresponding portion of an examination flagged. As still another example, in some embodiments, a content-based trigger can be activated when an examination taker spends more than a specified amount of time glancing far to the left, right, up, or down, and, in response thereto, video from a point before the examination taker looked away to a point after the examination taker no longer looked away can be recorded and the corresponding portion of an examination flagged. As still another example, in some embodiments, a content-based trigger can be activated when a student is determined to not be within a webcam's view. As still another example, in some embodiments, a content-based trigger can be activated when a window focus changes, and, in response thereto, video clips of a computer display and/or the user of any suitable length(s) can be recorded. As yet another example, in some embodiments, a content-based trigger can be based on eye tracking. As still another example, a content-based trigger can be based on facial recognition. As still another example, in some embodiments, a content-based trigger can be based on gesture recognition. As still another example, a content-based trigger can be based on motion tracking.

In some embodiments, a content-based trigger can count the number of faces visible by a camera in order to generate incidents when the number of faces changes. Counting of faces can be implemented in some embodiments using public domain computer vision software such as OpenCV described in Bradski, G., “The OpenCV Library,” Dr. Dobb's Journal ofSofwvare Tools, 2000, which is hereby incorporated by reference herein in its entirety.

In some embodiments, a content-based trigger can detect whether the user is facing the monitor or gazing away. Detecting whether the user is facing the monitor or gazing away can be implemented in any suitable manner. For example, this detecting can be performed using a morphable model to reconstruct a 3D pose of the face (e.g., as described in Rikert, T. F., & Jones, M. J., “Gaze estimation using morphable models,” Proceedings of Third IEEE International Conference on Automatic Face and Gesture Recognition, Nara, Japan, pp. 436-441, 1998, which is herein incorporated by this reference in its entirety). As another example, this detecting can be performed by comparing current images to images of the user looking at or away from the screen that were captured during a system configuration step. One or more threshold(s) can be set to allow a user to look away for some amount of time and/or some number of times before an incident is triggered.

In some embodiments, a content-based trigger can detect audio anomalies. For example, a trigger can be activated when a loss of audio is detected, and, in response thereto, the screen can be recorded and the portion of the examination with no audio input can be recorded. A content-based trigger can be activated based on the noise level in a room exceeding a certain threshold. Detecting audio anomalies can be achieved by applying a threshold to an audio signal, or to the output of a low-pass filter such as a five second box filter applied to the audio signal, so that, when the amplitude of the signal exceeds the threshold, the trigger will create an incident that may be reported to the server. Detecting audio anomalies can be performed as described in Liao, L., & Gregory, M. A., “Algorithms for speech classification,” Proceedings of ISSPA '99, Brisbane, Australia, vol. 2, pp. 623-627, 1999, which is hereby incorporated herein by this reference in its entirety.

In some embodiments, any suitable trigger (e.g., a time-based trigger, a content-based trigger, etc.) can cause a dialog box with a question to be presented and, if the student does not respond within a certain amount of time, an incident can be reported, recorded, etc.

Any other suitable triggers can additionally or alternatively be used to create an incident, and any other suitable actions can be performed during an incident, in some embodiments.

### Computer Network System

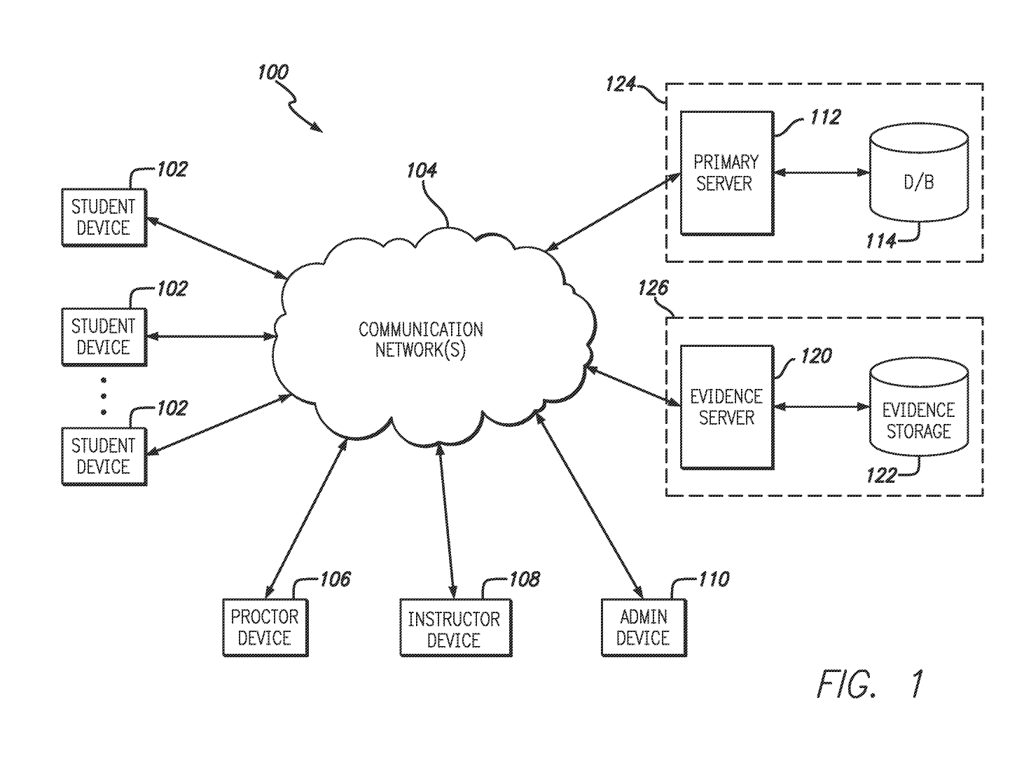

FIG. 1 illustrates an example of a computer network system 100 suitable for practicing the present some embodiments and methods of the invention. As shown, the system 100 can include one or more student devices 102, a communication network 104, a proctor device 106, an instructor device 108, an administrator device 110, primary computer system 124 including a primary server 112 and a database 114, an evidence computer system 126 including and evidence server 120 and evidence storage 122. Users can access the system via student devices 102, coupled to the primary server 112 and the evidence server 120 via the communication network 104. The communication network(s) 104 can be any suitable network or combination of networks for communicating data. For example, in some embodiments, the communication network(s) can include wire networks, wireless networks, the Internet, local area networks, wide area networks, telephone networks, cable television networks, satellite networks, etc.

Proctor device 106, instructor device 108, and administrator device 110 can be any suitable device or devices for enabling a proctor, an instructor, and an administrator, respectively, to access and configure activities, triggers, and trigger actions, monitor incidents, review evidence, review analytics, control access by users (e.g., students, proctors, administrators, instructors, etc.), etc. For example, devices 106, 108, and 110 can be a general purpose computer, a special purpose computer, a mobile phone, a laptop computer, a tablet computer, a desktop computer, etc. In some embodiments, the proctor device 106 can run a proctor client (i.e., a program). The proctor client can perform functions for configuring activities, triggers, and trigger actions, monitoring incidents, reviewing evidence, reviewing analytics and/or performing any other suitable function. The proctor client can be implemented as software that executes on a proctor device or as hardware that is part of a proctor device.

The student devices 102 can be any suitable devices for enabling a user to perform a computer-user activity. For example, a student device can be a general purpose computer, a special purpose computer, a mobile phone, a laptop computer, a tablet computer, a desktop computer, etc. In some embodiments, a student device 102 runs a student client (i.e., a program). A student client can be implemented as software that executes on a student device, or it can be implemented as hardware that is part of a student device. The student client can perform functions, as described in more detail below, for detecting when a trigger has occurred, performing an action corresponding to a trigger, and/or performing any other suitable function. In some embodiments, the clients can be launched from other software, such as Blackboard, and can work in conjunction with other software, such as lock-down browsers.

In some embodiments, the instructor device 108 can run an instructor client (i.e., a program). An instructor client can be implemented as software that executes on an instructor device, or it can be implemented as hardware that is part of an instructor device. The instructor client can perform functions for specifying or configuring activities, triggers, and trigger actions, monitoring incidents, reviewing evidence, reviewing analytics, controlling access by users (e.g., students, proctors, administrators, instructors, etc.) and/or performing any other suitable function. More particularly, for example, the instructor client may allow an instructor to add examinations as activities, authorize students to access an activity, review one or more incidents flagged as cheating by a proctor and determine if a student was indeed committing a violation, give the final decision on whether an incident is a violation or not, and/or any other suitable action.

In some embodiments, the administrator device 110 can run an administrator client (i.e., a program). The administrator client can perform functions for configuring activities, triggers, and trigger actions, controlling access by users (e.g., students, proctors, administrators, instructors, etc.), delete un-needed evidence, and/or performing any other suitable function. An administrator client can be implemented as software that executes on an administrator device, or it can be implemented as hardware that is part of an administrator device.

Still referring to FIG. 1, each of the primary computer system 124 and the evidence computer system 126 includes a central processing unit (CPU) for processing data and program instructions, data storage and memory devices, and input and output devices, as are well known in the art. Computer systems 124, 126 can be implemented as one system, separate systems or distributed systems.

Primary server 112 can be any suitable server for providing access to database 114. In some embodiments, server 112 and database 114 can be integrated into a single device. The primary server 112 can hold configuration information about which activities are available and which types of incidents are allowed.

Database 114 can be any suitable mechanism for storing configuration information including: which students are in which courses, which exams are available, how triggers should be configured for the attempts, incident records, and/or any other suitable information. Preferably, the database 114 is a relational database, as is well known in the art. In some embodiments, database 114 can store any suitable analytics for analyzing incidents, evidence, and/or any other suitable information or content. These analytics can be used to: look for anomalies, update confidence values and/or other metrics for triggers, create and/or update reports summarizing the performance (e.g., based on the percentage of incidents that were dismissed or flagged) of various triggers, to update the triggers based on flagged and un-flagged incidents using machine learning, provide comparative data for students in a class so that the proctor/instructor can see if a pattern of infraction for a student or section is significantly different, and/or to perform any other suitable function.

The evidence server 120 can be any suitable server for providing access to evidence storage 122. In some embodiments, evidence server 120 and storage 122 can be integrated into a single device. Evidence server 120 can provide access to, and evidence storage 122 can store, any suitable evidence, such as video clips captured from a camera attached or built-in to a user's computer, audio clips captured from a microphone attached-to or built-in to a user's computer, screenshots captured from a user's computer, keystrokes made on a user's computer, etc. The primary server 112 and the evidence server 120 can be deployed on virtual servers or can be hosted locally at a site.

As described above, student device(s) 102, proctor device 106, instructor device 108, administrator device 110, primary server 112, and/or evidence server 120 can be any of a general purpose device such as a computer or a special purpose device such as a client, a server, etc. Any of these general or special purpose devices can include any suitable components such as a processor (which can be a microprocessor, digital signal processor, a controller, etc.), memory, communication interfaces, display controllers, input devices, etc.

In some embodiments, any suitable computer readable media can be used for storing instructions for performing the processes described herein. The computer readable media can be transitory or non-transitory. By way of example non-transitory computer readable media can include: magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. Transitory computer readable media can include, by way of example: signals on networks, in wires, conductors, optical fibers, circuits, any suitable media that is fleeting and devoid of any semblance of permanence during transmission, and/or any suitable intangible media.

Upon reading this specification, those skilled in the art will understand that, under appropriate circumstances, considering issues such as developments in computer hardware, software and connectivity, etc., other network configurations and devices also may suffice and various operating systems, programming languages and database management systems can be used.

Although various embodiments are described herein in connection with computer-based education, in some embodiments, the mechanisms described herein can be used for any other suitable application, such as dating sites (e.g., to make sure a party to a conversation is who they say they are, etc.), online banking applications, employee monitoring (e.g., to make sure air traffic control operators are paying attention and to raise alarms when they are not), etc.

### Activity Monitoring Process

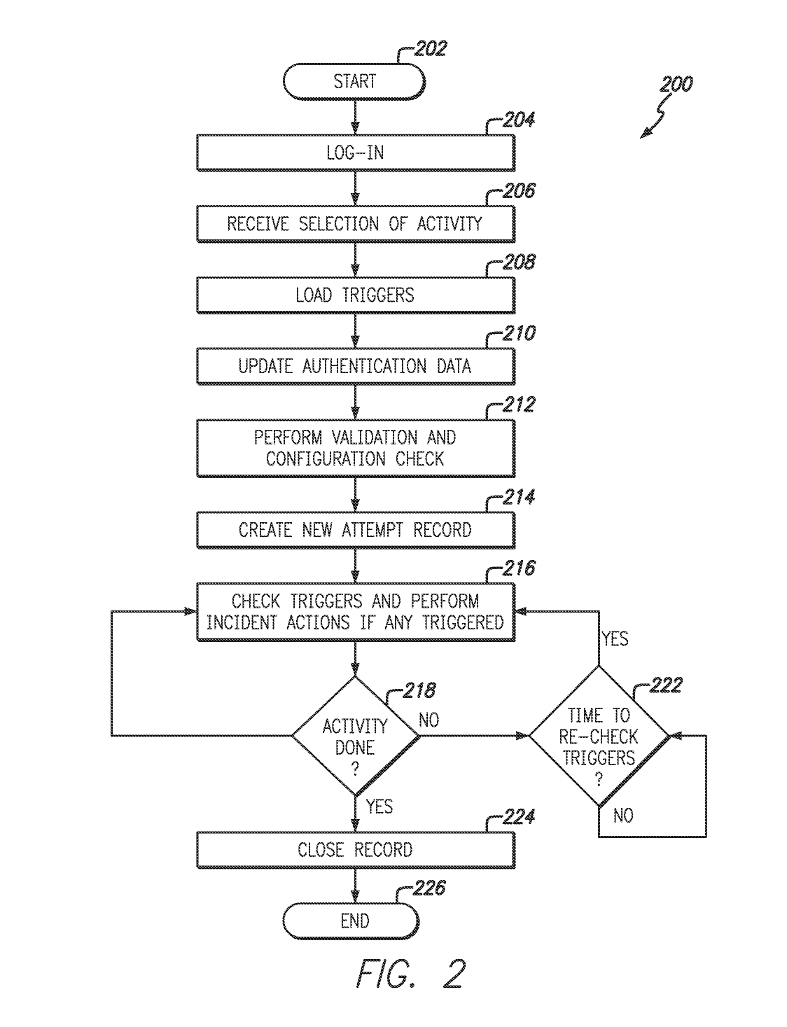

Turning to FIG. 2, an example of a process 200 for a student device 102 in connection with the monitoring of an online activity using the system of FIG. 1 is shown. As illustrated, after process 200 begins at 202, the student device 102 can prompt a user/student to log-in and authenticate himself/herself with the primary server at 204. Any suitable mechanism for logging-in can be used. For example, in some embodiments, a user can enter a user name and password. Next, the student device 102 receives a selection of an activity from a user at 206. Any suitable activity can be selected and this selection can be made in any suitable manner. For example, this activity can be “Take an English 101 final examination,” “Watch Calculus 302 lecture,” etc. Activities can be made, for example, by making a selection from a drop-down menu, by performing a search of available activities and selecting from a search results list, etc.

At 208, triggers and the corresponding actions related to the selected activity can be loaded. These triggers and actions can be loaded from any suitable location, such as from database 114 via primary server 112, in any suitable manner.

Authentication data for the user can then be updated at 210. Any suitable authentication data can be updated, and this data can be updated in any suitable manner. For example, authentication data can include voice samples, images of the students face/head, etc. Process 200 can then perform a validation check and/or a configuration check of the student's environment at 212. Any suitable check(s) can be performed. For example, in some embodiments, such checks can include asking the user to adjust the field of view of a camera, taking a snapshot/video clip of the environment without the examination taker, taking a snapshot/video of the environment with the examination taker's frontal face image in front, taking a snapshot/video of the examination taker's ears (e.g., to ensure headsets are not in use), taking screenshots of the examination taker's computer, recording audio background noise to ensure that a user's computer's microphone works and that the examination taker is in a quiet place, and/or performing any other suitable action. As another example, such checks can include determining whether an examination taker's computer is using a battery and if the battery has enough charge for the examination. As still another example, such checks can include determining whether an examination taker's computer has enough space to cache the examination. In some embodiments, if such checks suggest an abnormality (e.g., the environment is too noisy), any suitable action can then be taken. For example, the attempt may be flagged, the user may be prompted to take corrective action, etc.

At 214, a new attempt record can be created. Any suitable data can be included in the new attempt record and this record can be created at/on any suitable destination. For example, in some embodiments, the name of the student, the date, the time, the name of the activity, an Internet Protocol address for the student's computer, and/or any other suitable data can be included in a new attempt record created in the database. Then, at 216, process 200 can check triggers for incidents and perform the actions associated with the incidents. Any suitable triggers can be checked and any suitable actions performed. For example, triggers and corresponding actions as described above can be checked and performed.

As a more particular example, when a trigger is activated, evidence from a student device can be collected. Any suitable evidence can be collected. For example, collected evidence can include: a type identifier for an incident, an incident's start time and duration, a confidence score indicating an estimate of the probability that the incident is not a false positive, video, audio, key strokes, screen capture images, data, video clips of a portion or the entirety of an incident or an attempt (e.g., captured by an available video capture device such as a Webcam), audio clips of a portion or the entirety of an incident or an attempt (e.g., captured by an available audio capture device such as a microphone), screen captures (e.g., containing the user's entire desktop (which can include desktops of multiple monitors in some embodiments), information indicating that a keyboard and/or a mouse was disconnected from and/or reconnected to the student device (e.g., using a KVM switch), information on “black-listed” programs that may be running (such as a virtual network controller), “black-listed” keystrokes, etc.

In some embodiments, information on keystrokes can be limited to prevent disclosure of confidential information of the student, such as student user id's, passwords, social security numbers, etc. Any suitable mechanism can be used to recognize confidential information and such information can be converted to any suitable form (e.g., such as all asterisks) to obscure the original information.

In some embodiments, evidence can be stored on the student device for any suitable period of time. For example, evidence can be stored on the student device: until the evidence can be transferred to the evidence storage, until a suitable device requests the evidence and the evidence has been transferred to that device, until the evidence has been deleted, etc. The evidence can be stored in any suitable manner. For example, the evidence can be encrypted and/or digitally signed to prevent tampering.

Referring again to FIG. 2, at 216, it can be determined whether the activity is completed. If so, process 200 can close out its record for the attempt at 218 and end at 220. Otherwise, process 200 can determine at 222 if it is time to re-check the triggers. The triggers can be checked at any suitable frequency, including continuously. If not process 200 can loop back to 222 to wait for the time to re-check the triggers. If it is time to re-check the triggers, then process 200 can loop back to 214.

### Proctor/Instructor Interface

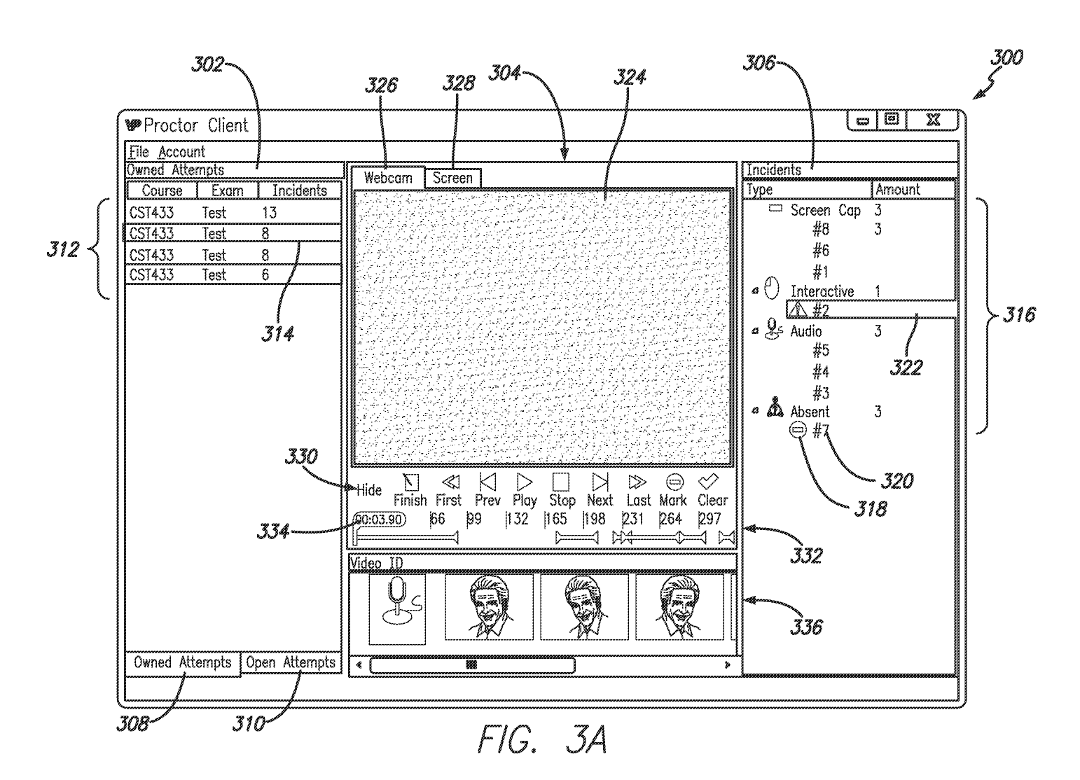

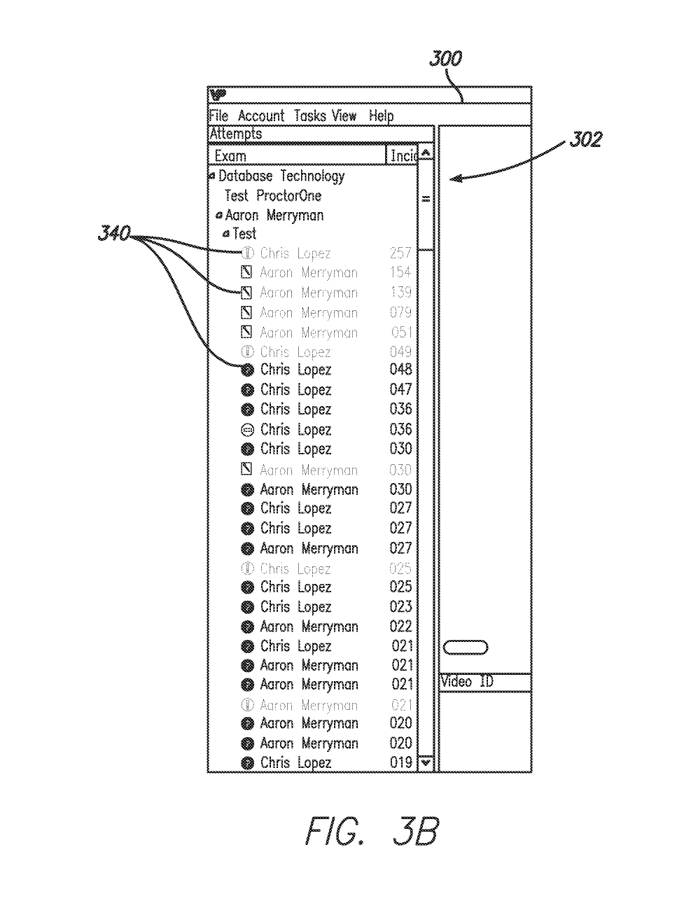

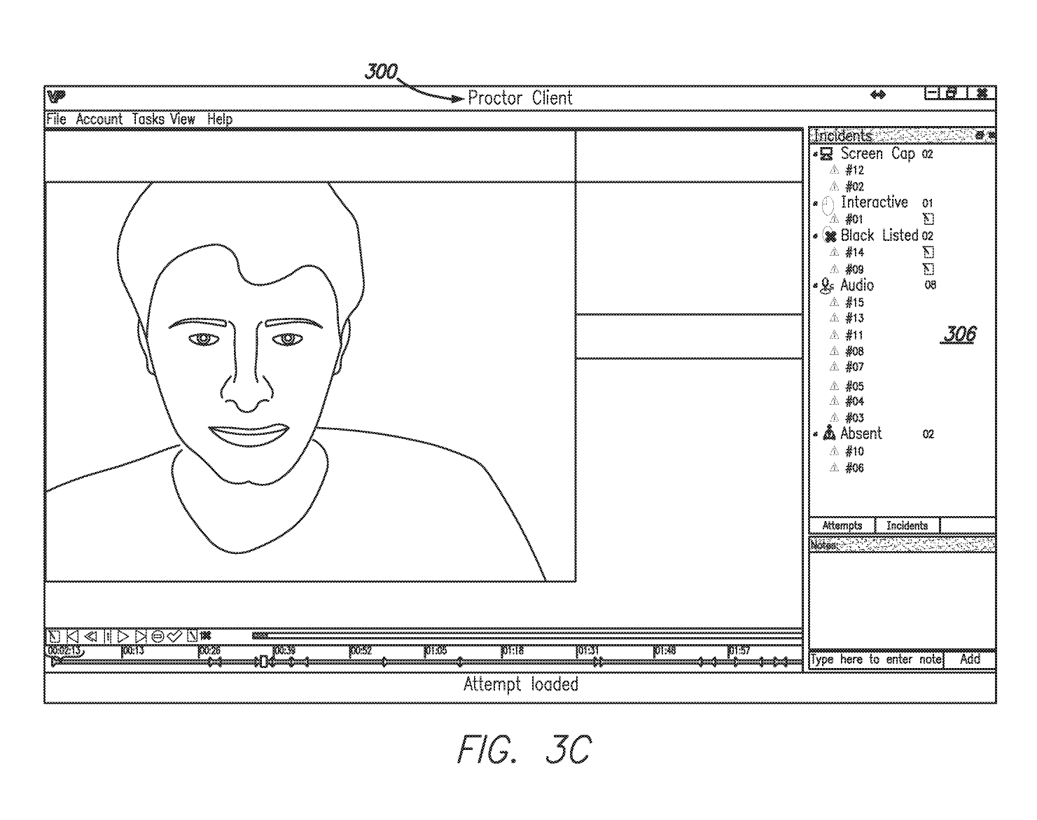

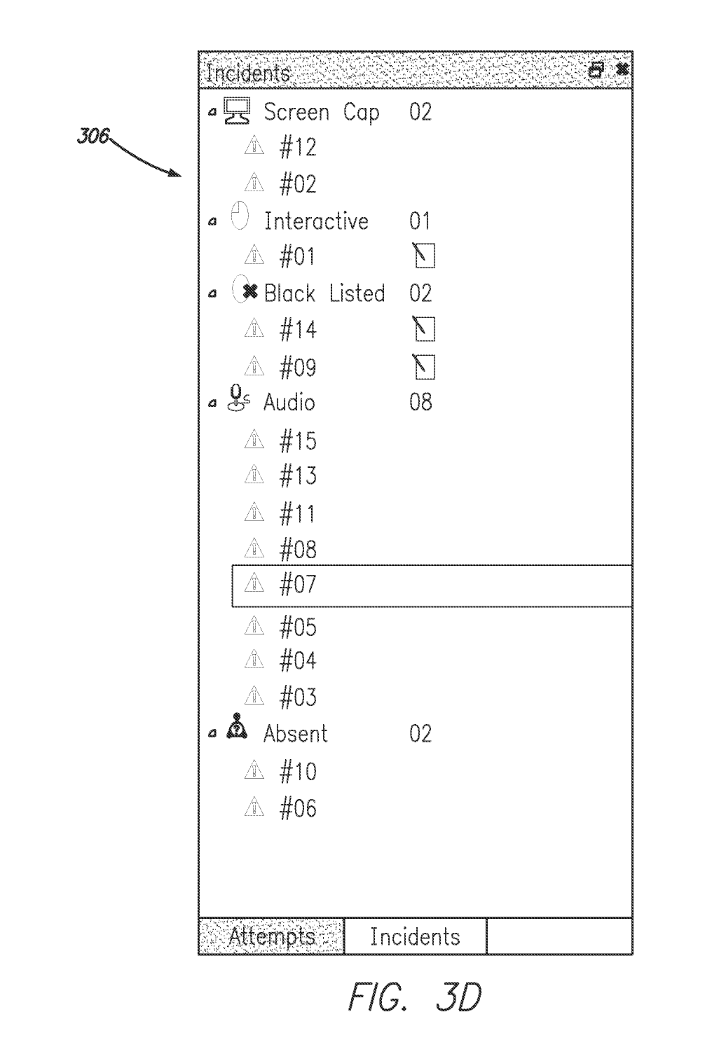

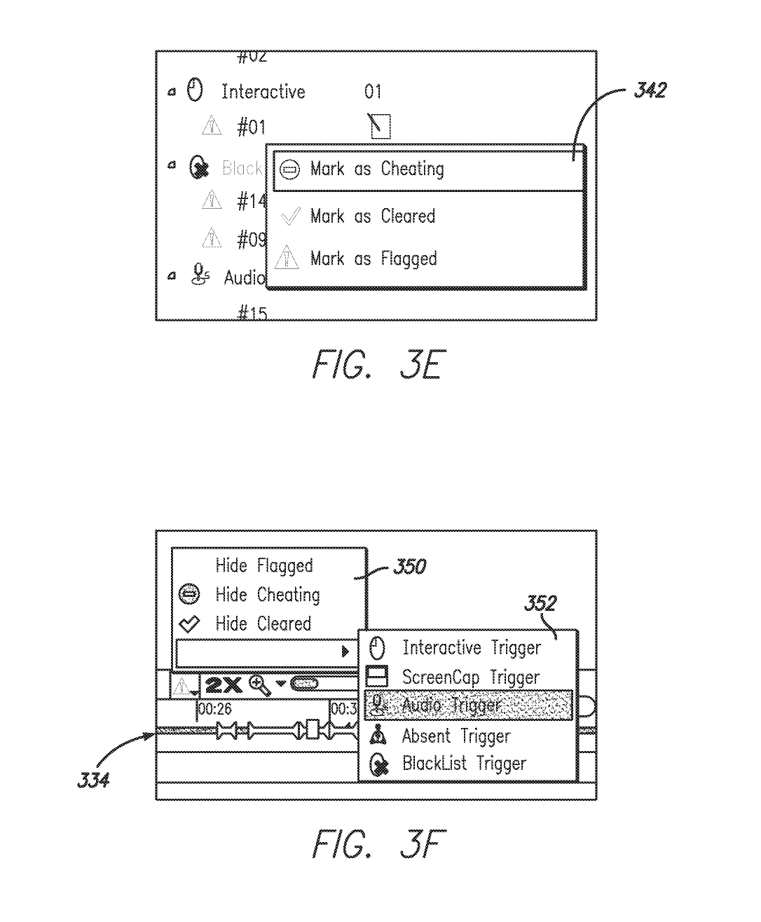

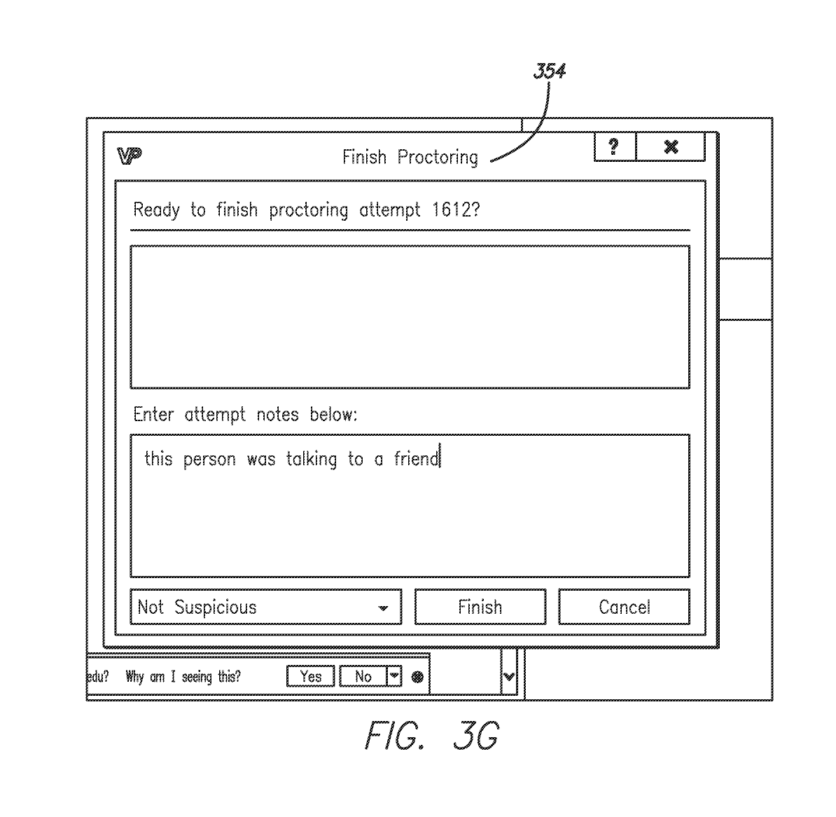

FIG. 3A shows an example of a proctor interface 300 according to one embodiment of the invention. As illustrated, the proctor interface 300 can include an attempts list area 302, an evidence review area 304, and an incidents list area 306. The attempts list area 302 can include tabs 308 and 310 for showing owned attempts (attempts that are specific to a given proctor) and open attempts (attempts that can be reviewed by any available proctor). For each listed attempt 312, a description of the attempt (shown in FIG. 3A as a course name and an exam name), a number of incidents detected, and/or any other suitable information can be presented. When a proctor or instructor (who is registered in the system) logs in, the system populates the attempts list area 302 with different exams taken by students. Exams taken by students that are assigned to a proctor will show up under that proctor's name. As shown in FIG. 3B, attempts can be shown with an attempt status indicator 340 to indicate which attempts have not been downloaded to the proctor's computer, which ones have been downloaded and have not been fully reviewed, and which ones have been fully reviewed. Authentication data (such as known facial images of the student) can be presented in a video ID area 336 so that a proctor can confirm the identity of a student.

Still referring to FIG. 3A, upon selecting an attempt from area 302 (using, for example, a highlight region 314), information regarding the attempt is downloaded to the proctor computer (see, e.g. FIG. 3C), including incidents 316 corresponding to the selected attempt, which can be shown in incidents list area 306. As shown in the examples of FIG. 3A and FIG. 3D, these incidents 316 can be organized by type (e.g., screen capture, interactive, audio, absent, etc.), and the number of incidents in that type can be indicated. The incidents can be organized in any other suitable manner, such as by confidence level. Each incident can be shown with an incident status indicator 318 and an incident number 320. This status indicator can indicate that the incident is to be reviewed (shown by an exclamation point in a triangle), cleared (shown as a check mark), marked (shown as a do not enter sign), and/or has any other suitable status.

Upon selecting an incident (using, for example, a highlight region 322), evidence for the incident can be presented in the evidence review area 304 (when applicable), played on speakers, etc. For example, video from a webcam can be presented in a webcam region 324 upon selecting a webcam tab 326 and video from a screen can be presented in screen region 324 upon selecting a screen tab 328. In some embodiments, multiple pieces of evidence and/or multiple types of evidence can be presented at the same time. This evidence can be reviewed to determine, for example whether the incident should be reported as cheating.

Controls 330 can be used to hide the incident (or all incidents of that type or confidence level), finish and record notes on the incident, go to the first piece of evidence on the incident, go to the previous piece of evidence on the incident, play the current piece of evidence on the incident, stop playing the evidence on the incident, go to the next piece of evidence on the incident, go to the last piece of evidence on the incident, mark the incident (which can cause the incident and attempt to be flagged for further review), clear the incident, and/or perform any other suitable action with respect to the incident and/or evidence on the incident. For example, using controls 330, a proctor can record text annotations, video annotations, or audio annotations that are linked to particular pieces of evidence, incidents, and/or attempts. A proctor might want to leave notes to the instructor or other proctors looking at the attempt or a specific incident. As another example, using controls 330, a proctor can play video evidence back at increased speed, simultaneously play multiple media types of evidence, simultaneously play clips from multiple incidents, simultaneously play clips from multiple attempts, create “chapters” of incidents and/or evidence, simultaneously show snapshots from multiple key times in an audit trail, etc. As another example, incidents can be cleared, flagged or marked as cheating, such as with a pop-up menu 342 like that shown in FIG. 3E accessible from the incidents list 306. Any cheating clips can be sent to the instructor for final evaluation. During proctoring, the status of incidents can be reviewed and changed. As soon as an incident is edited the changes are sent to the server. Hiding incidents by either flag status or incident type can help speed up the proctoring process by allowing the proctor to look for something specific.

Referring again to FIG. 3A, a timeline 332 can be provided to show incidents at different times during an attempt. These incidents can be illustrated as bars on the time line and can be colored (e.g., green for cleared incidents, red for incidents marked as cheating, and yellow for suspicious incidents) to reflect their statuses. During proctoring, the status of incidents can be reviewed and changed (see, e.g., FIG. 3E). By clicking on a portion of the timeline, evidence for that portion can be presented. By moving an indicator 334 on the timeline, different portions of the evidence can be quickly reviewed. There may be times when many incidents are generated and at very close times. This is especially true with long exams. To address these issues, a tool can be provided to allow a proctor to zoom in and out of the timeline. Playlists can be created and the system can play all of the clips corresponding to the section of the timeline where a proctor clicked. If there are multiple media types, such as webcam and screen capture, a proctor can switch between them.

Also, the proctor can select which incident types he wants to see in order to proctor exams more effectively. As shown in FIG. 3F, for example, a proctor can select which incidents he or she wishes to view by status or trigger, such as by using pop-up menus 350, 352.

Once all of the incidents have been dealt with, the proctor can finish proctoring the exam. As shown in FIG. 3G, the proctor can finish reviewing an attempt by giving an overall suspicion level and a comment using a Finish Proctoring dialog box 354.

### Student Interface

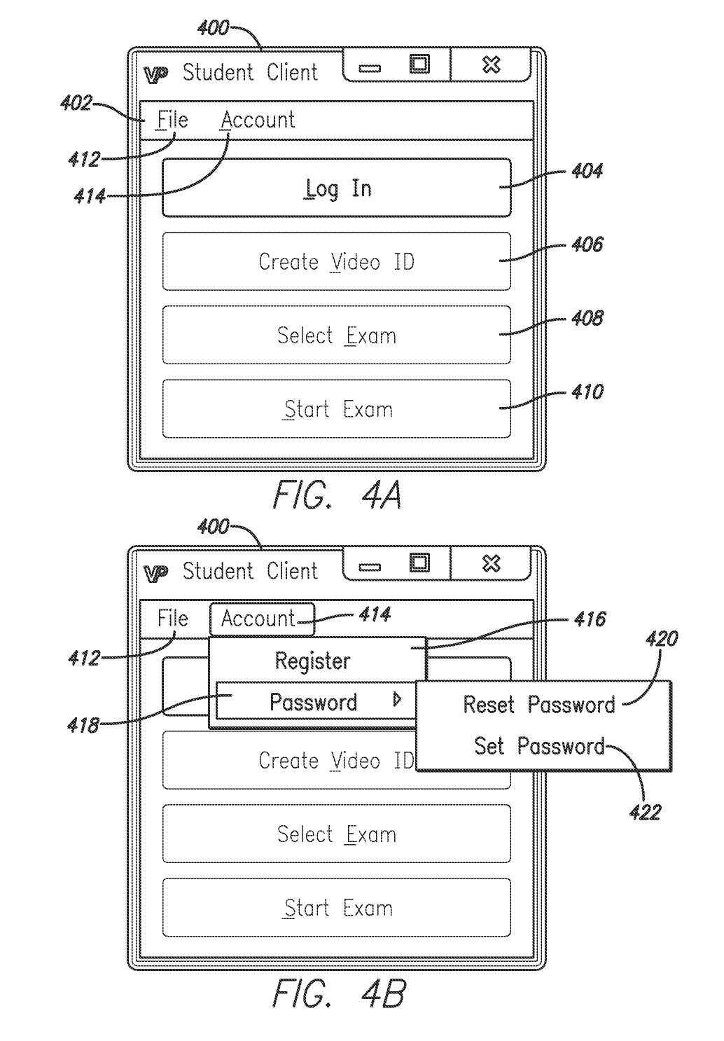

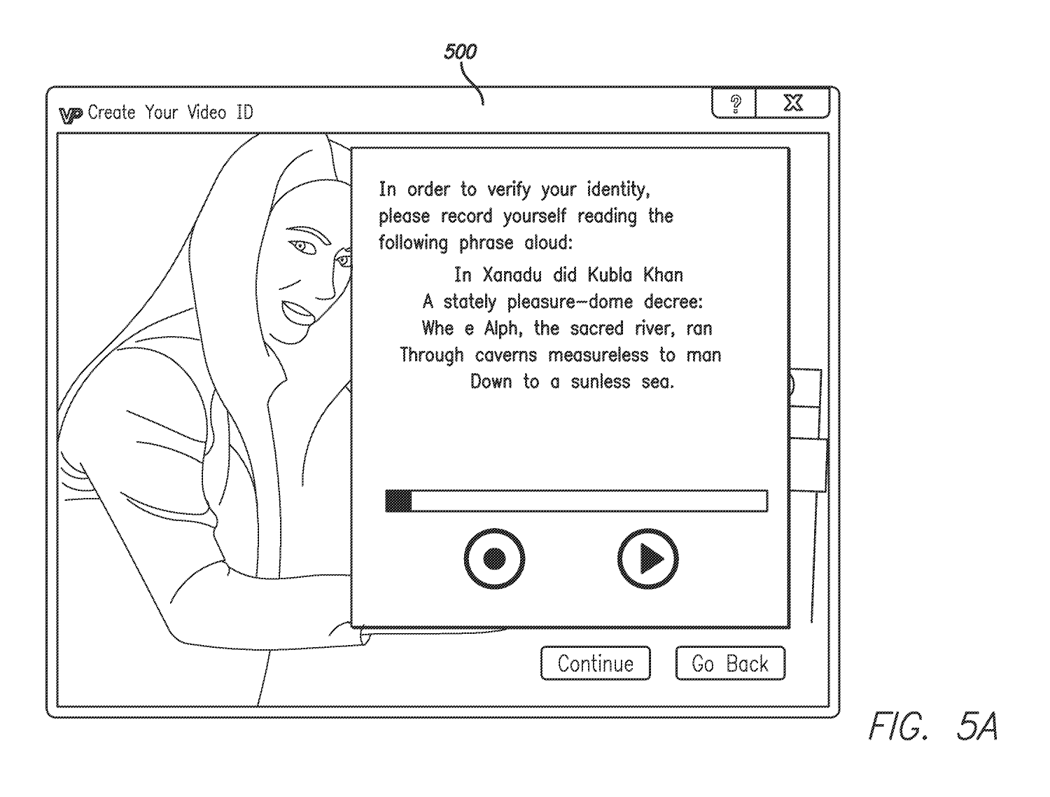

FIGS. 4-8 show an example of a user interface 400 for a student client. Referring to FIGS. 4A and 4B, a Student Client main window 400 includes a user navigation menu 402, a Log In button 404, a Create Video ID button 406, a Select Exam button 408 and a Start Exam button 410. The user navigation menu 402 includes a File menu option 412 and an Account menu option 414. When the main window 400 first opens, the Log In button 404 can be the only one available to allow the student to login to the system. After logging in, the student can have the ability to access the other areas of the student interface.

When the student first runs the program they must register. The student can be given an ID by their instructor for registering. Under the Account menu option 414 the student can find a Register submenu 416 and a Password submenu 418, as seen in FIG. 4B. By selecting the Register submenu 416, the student can create a new account. By hovering over the Password submenu 418, the Student can access a Reset Password option and a Set Password option for managing the student's password. Under the File menu option 412, the student can exit the program alternatively to pressing the X in the top right corner of the window.

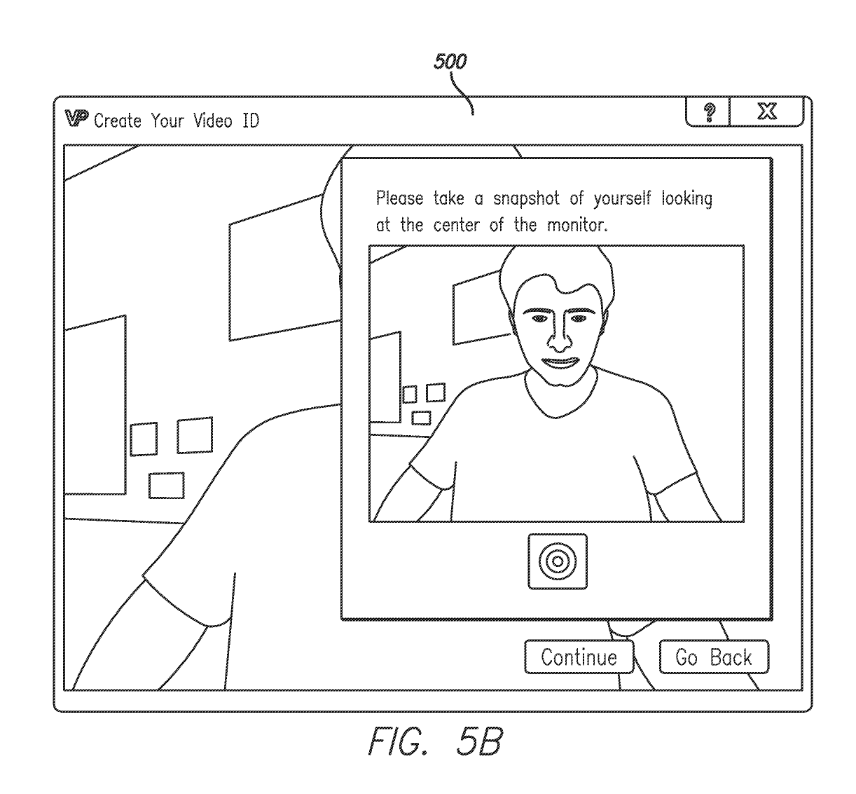

Referring again to FIG. 4A, after a student logs in for the first time, the Create Video ID button 406 can become available for the student to create his or her profile in the system. If the student has created an ID before, they can be presented with an Update Video ID button rather than the Create Video ID button 406. The video ID is made up of a voice sample and a picture of the student. When the Create Video ID button 406 is selected the system displays a Create Video ID window 500 as shown in FIG. 5A. While in this window, the student is not allowed to proceed until certain requirements are fulfilled such as recording his or her voice or taking a snapshot. The first page of this wizard, as shown in FIG. 5A, requires the student to record his or her voice. The rest of the wizard, as shown in FIG. 5B, requires that the student take pictures of his or her face and other areas. This is used to verify and identify the student taking the exam. Updating the student's profile is important for both the student and the proctor, since physical features may change. After the voice sample and student pictures are taken, they are then uploaded for the server for the proctor or instructor to reference.

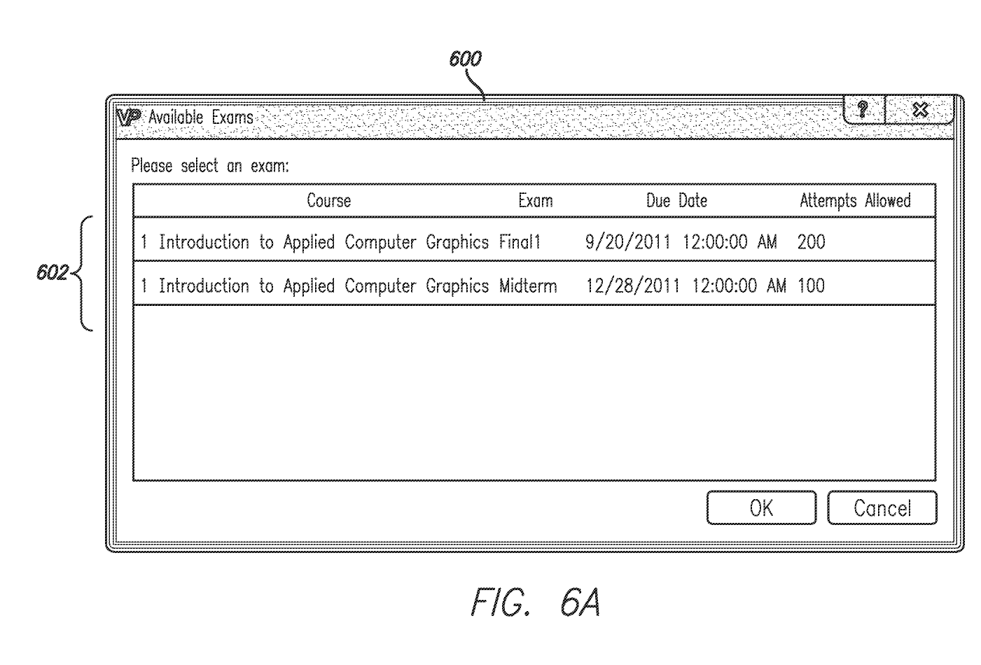

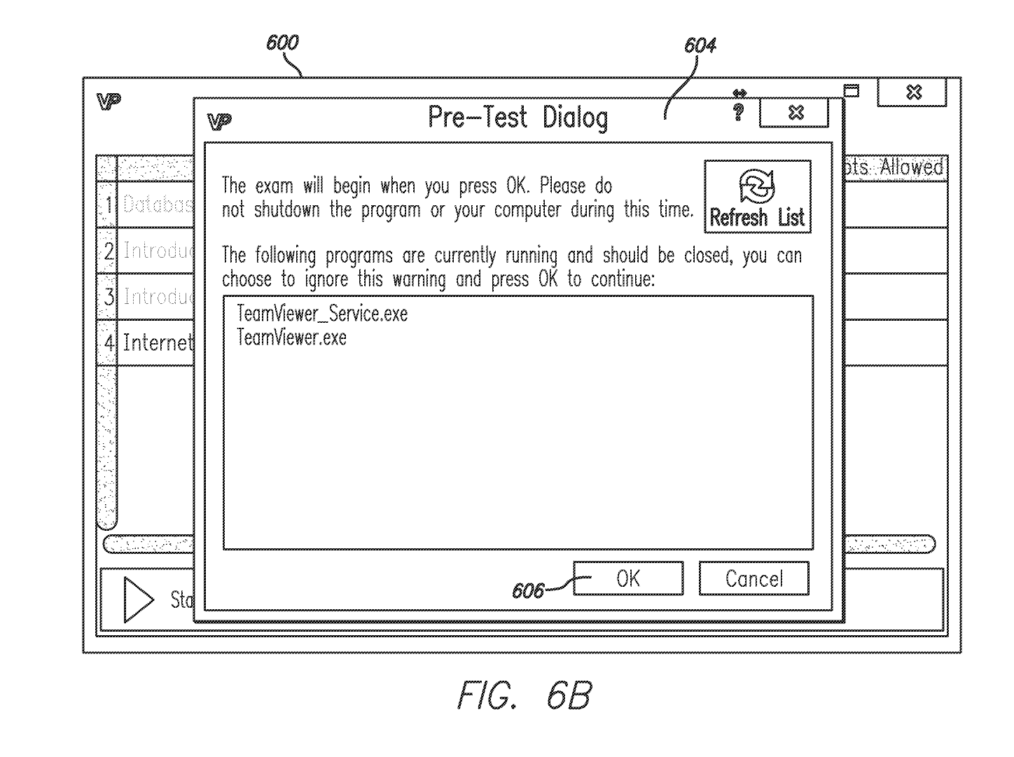

Referring again to FIG. 4A, the select exam button 408 can become available to the student after logging in and creating a video ID. Before beginning an exam, the student must select which test they would like to complete. When the user selects the Select Exam button 408, the system will display an Available Exams window 600, as shown in FIG. 6A, which is populated with the available exams 602 for the logged-in student. Information for the available exams is listed here for the student to see. Exams can be created by the instructor as described below. Instructors may allow the student to take an exam more than once.

After the student selects an exam from the available exams 602, a Pre-Test Dialog box 604 will appear, as shown in FIG. 6B, advising the student that the exam will begin after pressing the OK button 606 and directing the student to not close the program or shutdown the computer during this time. The student's environment is checked and data is recorded for the triggers to then use. For example, the student client program scans the student computer for blacklisted software (not allowed) or graylisted software (will be flagged for review by proctor). The Pre-Test Dialog box 604 displays all the blacklisted programs that are currently running on the student's computer. The student can choose to ignore this warning and continue taking the exam or close the blacklisted programs. If the student chooses to ignore the warning and a blacklist trigger is active, it can report all blacklisted programs running. An audio portion of the environment checker can be used to measure three different levels of sound: silence, typing, and speaking. These can take an average of the whole time spent in each stage to get the most accurate level of audio during those times. The student can be asked to remain silent while the system records audio for a given amount of seconds. The student can be asked to type a phrase and records audio while they are typing until a given amount of seconds have elapsed. The student can then be asked to read the phrase that they typed. If the student cancels this dialog without completing it, the start of the exam can be delayed.

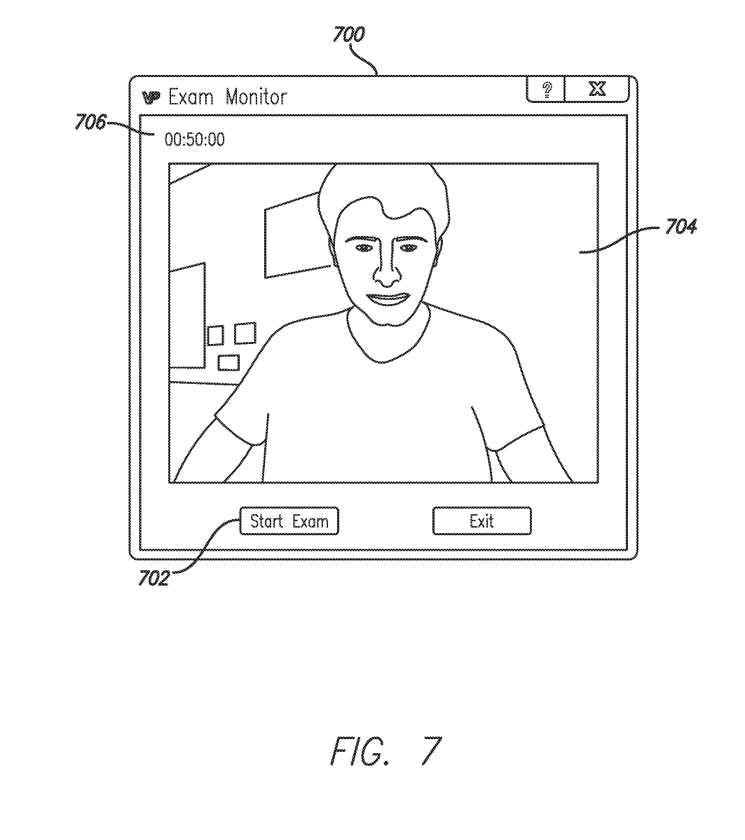

After the student selects the Pre-Test Dialogue box OK button 606, the system displays an Exam Monitor window 700 as shown in FIG. 7, which can include a video display 704 from the student computer webcam. The student can begin the test by clicking a Start Exam button 702. This will begin an exam timer display 706 counting down and open up any weblinks associated with the exam using the user's default browser. With the exam timer is counting down, the triggers will all activate and begin their analysis on the student.

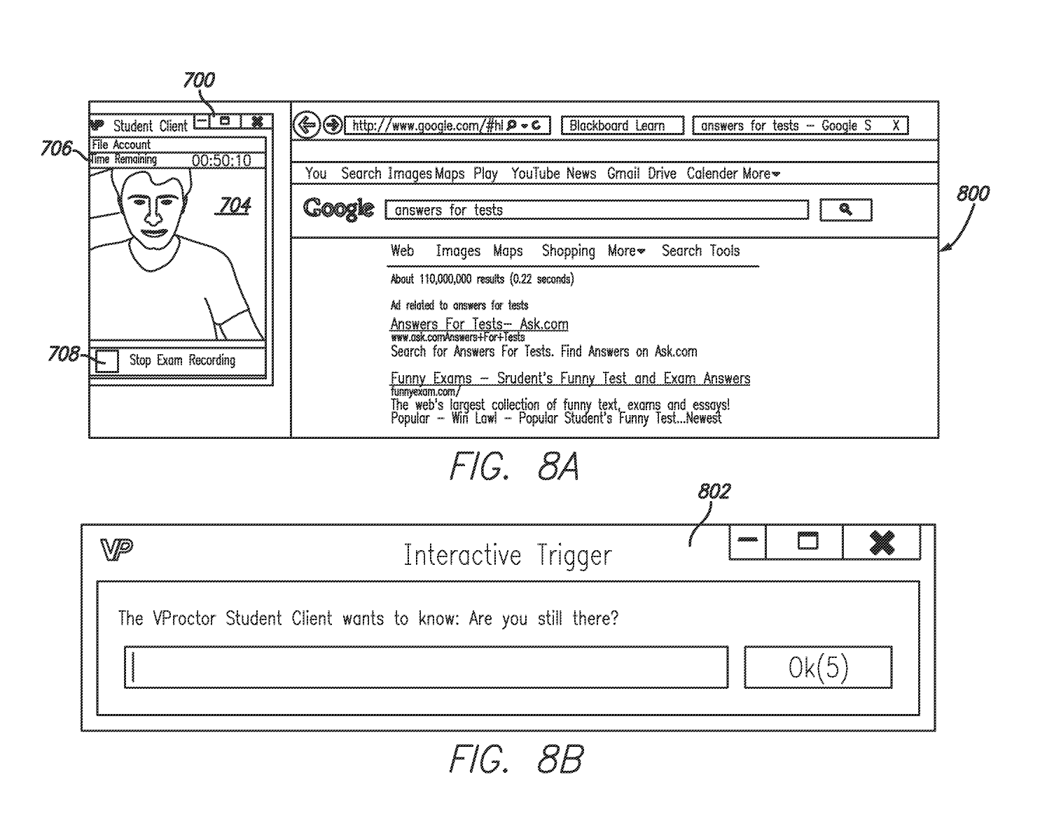

Referring to FIG. 8A, during the exam, an Exam Monitor window 700 can be displayed on the student's computer screen display 800 and trigger programs can activate, as explained above. When the student is done taking their exam, they can manually end it by pressing an End Exam button 708. The proctoring will automatically stop once the timer 706 reaches zero. The files can then be uploaded to the server and deleted off the student's computer. After the upload has completed, a dialog box can pop up asking if the student would like to take another exam.

During the exam, interactive triggers can activate with timers set by the instructor. As shown in FIG. 8B, an interactive trigger can display an Interactive Trigger dialogue box 802 to ask a question and based on that response (if there was one), trigger an incident. Screen capture triggers can activate when the student changes to a different window or tab. For example, if the student clicks off the blackboard site, the screen capture trigger can activate. A blacklist trigger can activate with a timer or at an interval set by the instructor to find all blacklisted programs running on the student computer and create a corresponding incident. An audio trigger can activate when the user talks too loudly. An absent trigger can activate when the student moves away from the computer for a specified number of seconds, which can be set by the instructor.

Should a trigger flag an incident, clips of the incident can be uploaded to the evidence server so that the instructor can further investigate and decide what to do to the student committing the violation.

### Administrator Interface

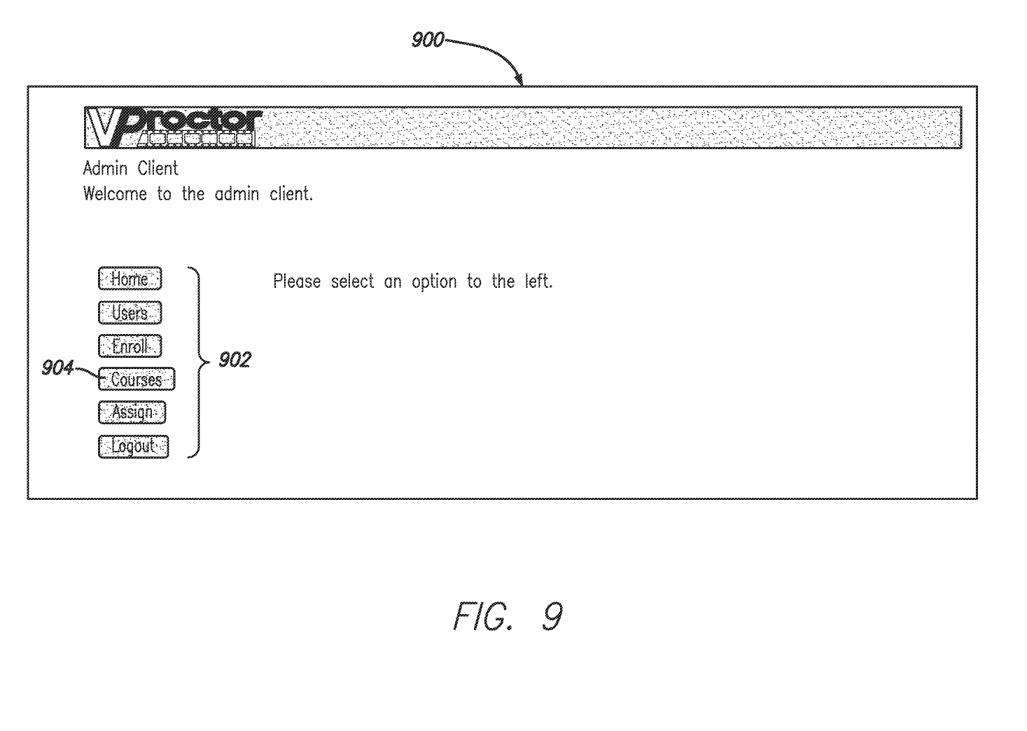

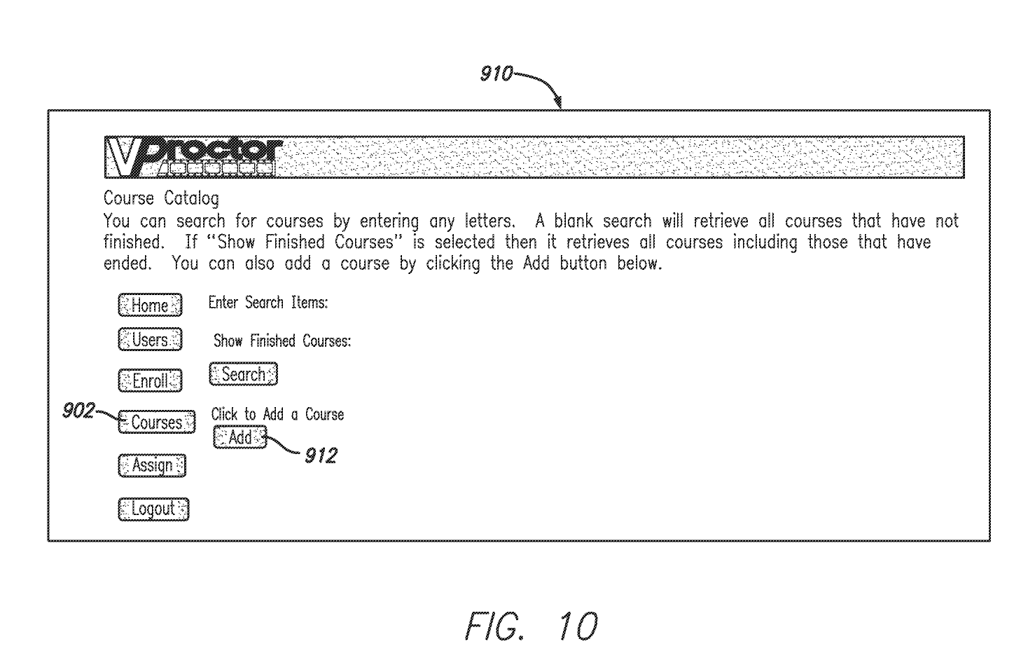

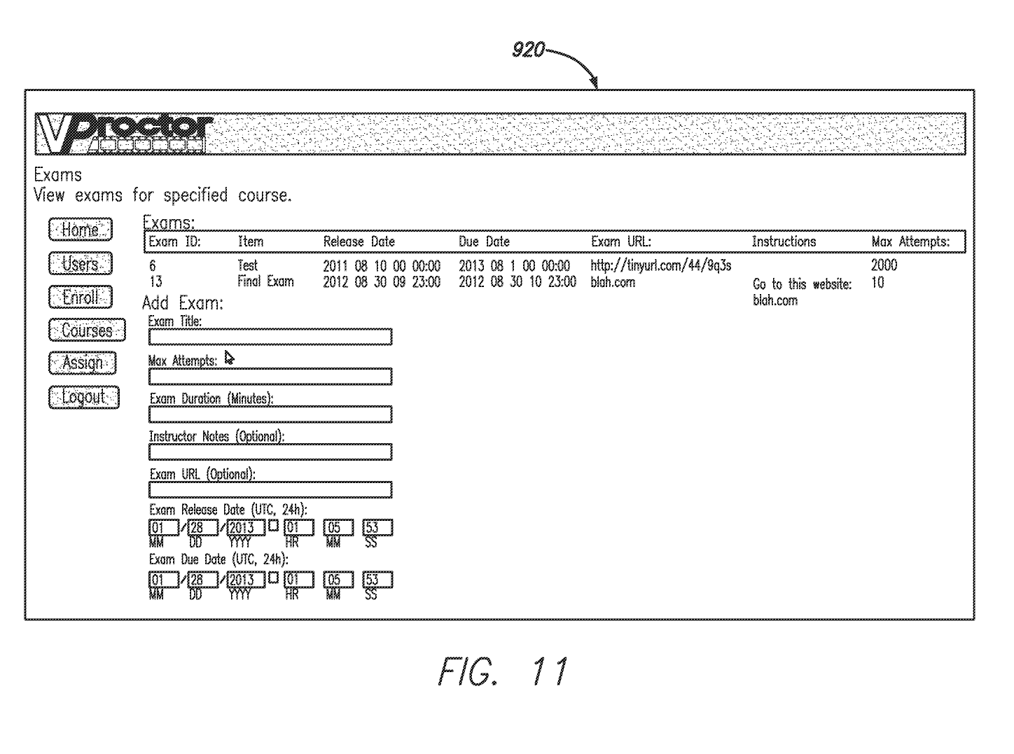

FIGS. 9-13 show an example of a computer interface 900 for use by an administrator for configuring courses, examinations and triggers according to some embodiments and methods of the invention. As illustrated in FIG. 9, after an administrative user logs in to the system using administrator device 110, the administrator client displays a Administrator Main window 900, which includes various menu selection buttons 902, including a Courses button 904. When the administrator selects the Courses button 904, a Course Catalogue window 910 is displayed, as shown in FIG. 10. From this window, course information can be searched using a Search button 914 and can be added to the database by selecting an Add button 912.

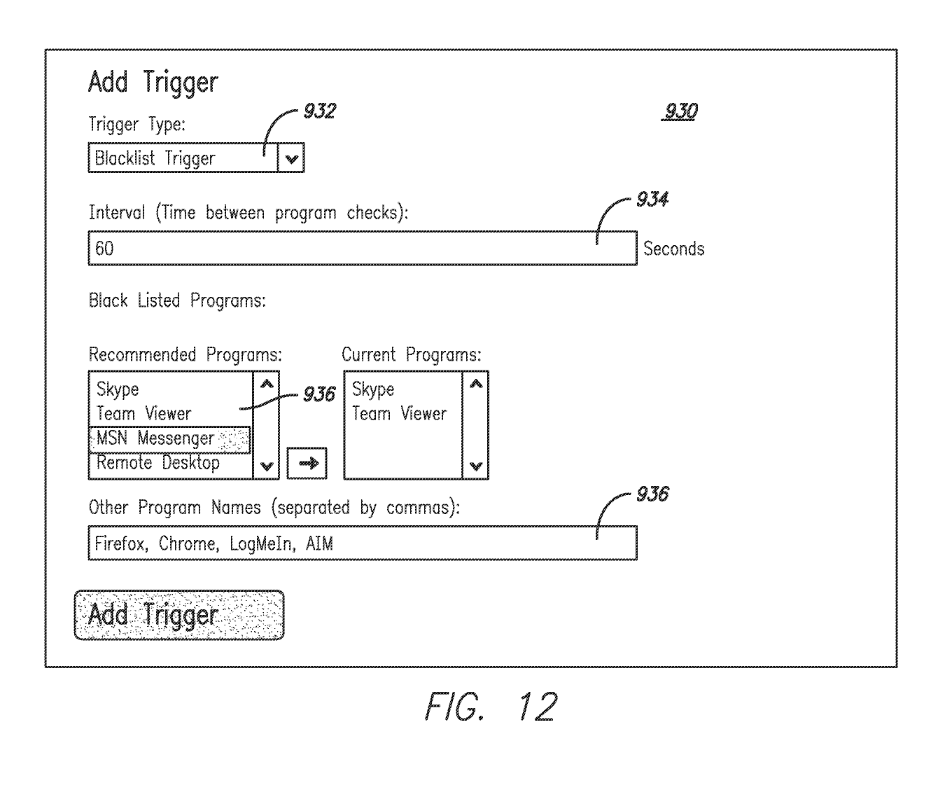

Referring to FIG. 11, the administrator program also can display an Exam window 920 for configuring examinations stored in the database.

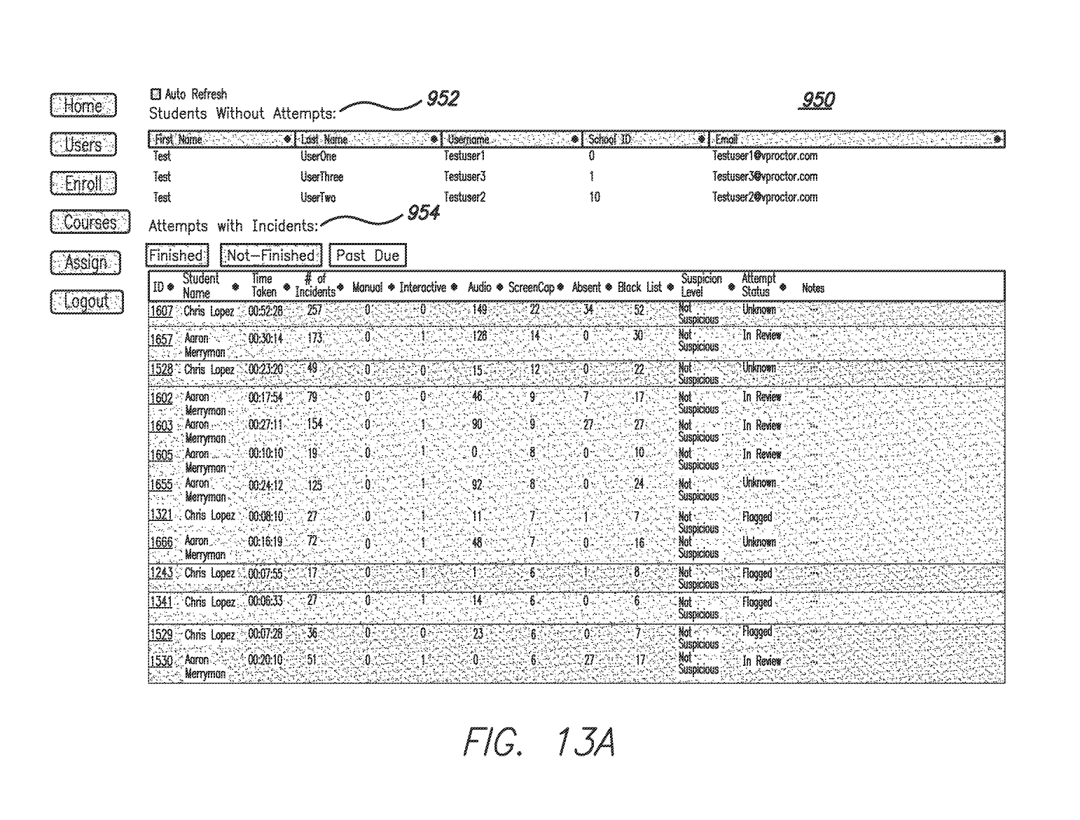

Referring to FIG. 12, the administrator client program can be used to add and configure triggers from an Add Trigger screen 930. For example, as shown in FIG. 12, the Add Trigger screen can include drop down menus for selecting Trigger Type 932, Trigger Interval 934 and Blacklisted Programs 936.

Typically, triggers will be initiated only from the time an exam starts, or any time after that, until the desired duration or end of the exam. Triggers are utilized in order to try to detect violations while taking an exam. Trigger types can include, for example, manual triggers, interactive triggers, noise triggers, screen capture triggers, absent triggers and blacklist triggers. Using the administrator interface 900, an administrator can set trigger characteristics available for selection by an instructor.

Manual Trigger.

In a manual trigger the instructor specifies the time when a clip recorded at that time specified should be uploaded, whether the student was in violation or not. For example, if a clip is recorded every two minutes and the instructor wants the videos from the beginning of the exam until four minutes into the test, then any clip recorded that contains the time specified is uploaded to the server where the instructor and or proctor can then analyze the clip. Options for a manual trigger can include:
1. Maximum number of incidents to cause throughout the exam. (0=unlimited)
2. Time between incidents in seconds.
3. Duration of incident in seconds. Must be less than the second option.

Interactive Trigger.

The instructor specifies the time and duration for a pop-up dialog to appear in which a question will be asked and require a response. If the dialog meets its end time and the user hasn't responded to it within the time allotted, then the clips during the time the trigger was initiated until its duration will be flagged and uploaded to the server for inspection. Options for an interactive trigger can include:
1. Time to start in seconds.
2. Duration of dialog before timing out.

Noise Trigger.

When initiated, a noise trigger will listen to the volume levels via the student's microphone and try to detect when the noise level in the room exceeds the threshold. If the noise level does indeed exceed the threshold then incidents will be uploaded to the server. Options for a noise trigger can include:
1. Threshold in hertz (Hz).

Screen-Cap Trigger.

After the exam starts, this trigger will monitor the windows the user is viewing. If the user goes to a window not white-listed by the program then a screen capture will be initiated and will end when the user returns back to a white-listed window. Options for a screen-capture trigger can include.
1. Number of milliseconds to screen record when top window title changes.

Absent Trigger.

This trigger checks whether or not a person is in the webcam's view. If the person is detected as not being there, then incidents will be uploaded to the server. Options for an absent trigger can includes;
1. Number of seconds a student's detected face can be out of view.

BlackList Trigger.

This trigger will create incidents with a list of running blacklisted programs. Options for a blacklist trigger can include:
1. Duration (seconds)
2. Blacklisted program names, e.g., skype, aim, logmein.

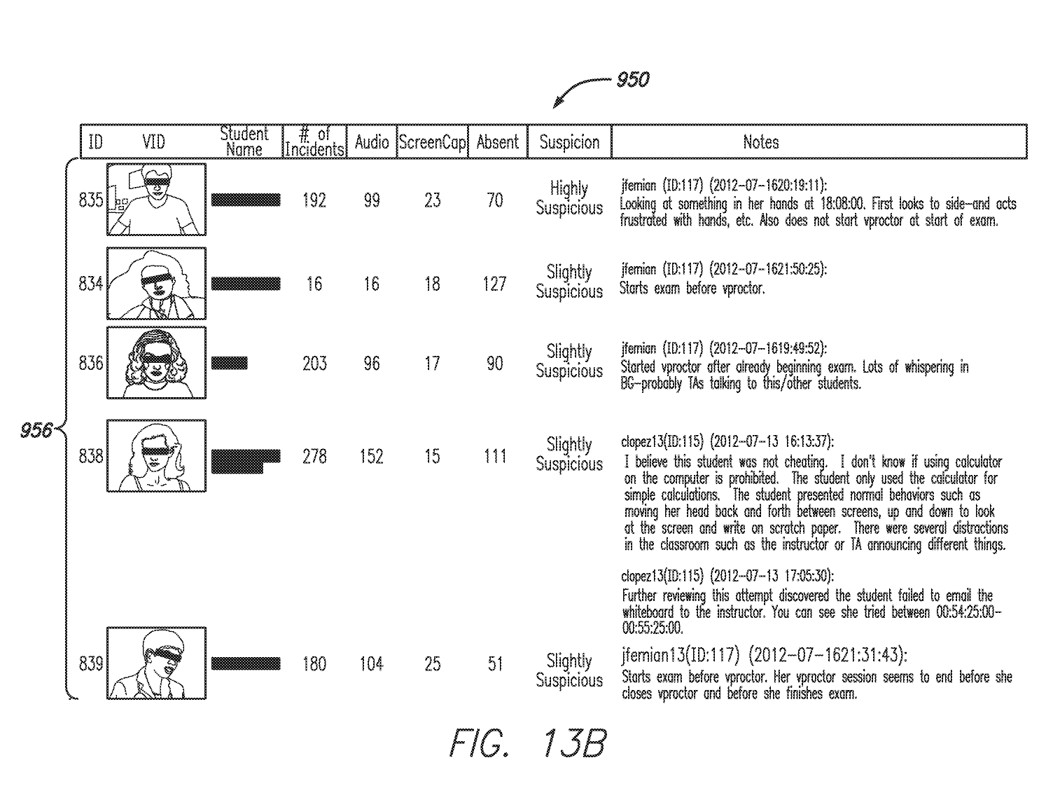

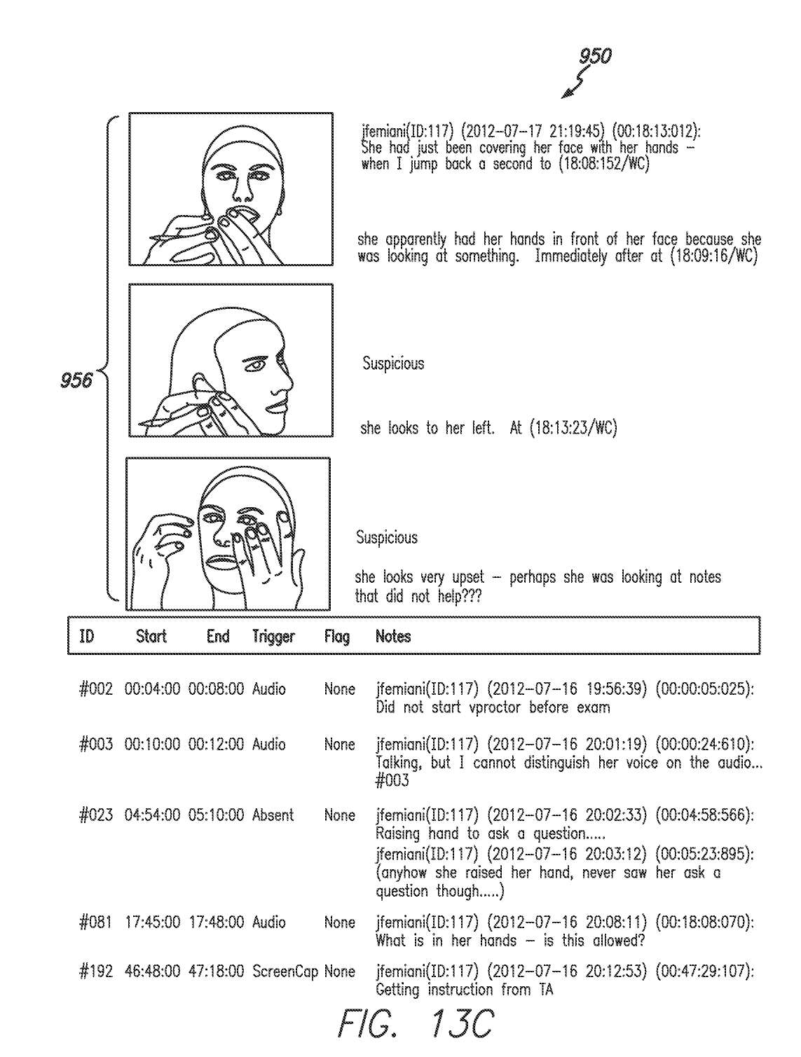

Referring to FIGS. 13A-13C, the administrator client program can be used to view a report of all activity on an exam from a Report screen 950. For example, as shown in FIG. 13A, such a report can include a Student's Without Attempts display section 952 and an Attempts With Incidents section 954. Reports can be sorted, for example, by overall number of incidents, or by the amount of any particular trigger. As shown in FIGS. 13B and 13C, reports can be generated with image data 956 pulled from the recordings in order to send data to an instructor.

From the foregoing, it will be understood that the methods and embodiments of the present invention will provide a number of advantages. For example, some methods and embodiments allow for any combination of triggers to be picked on a per exam basis. For example, video or audio triggers can be turned off while allowing other triggers. Some methods and embodiments can allow for offline proctoring: the incident data can be collected and stored on the servers for instructors and proctors to review offline, thereby allowing proctors to monitor exams at any time rather than at a particular time. This also allows students to take an exam when it is most convenient for them. The methods and embodiments allow for easy and auditing. Suspicious activities can highlighted by timeline or by category so that the proctor can review exams at a fast pace and can mark incidents as potential infractions. These can be further reviewed by an instructor (an instructor might have multiple proctors for a large class/section). Some methods and embodiments of the invention can provide comparative data for the students in the class so that the proctor/instructor can see if a pattern of infraction for a student or section is significantly different. This allows for focusing on and evaluating activities that present a high probability of cheating.

Upon reading this disclosure, those skilled in the art will appreciate that various changes and modifications may be made to the embodiments and methods of the invention and that such changes and modifications may be made without departing from the spirit of the invention. Therefore, the invention in its broader aspects is not limited to the specific details, representative devices, and illustrative examples shown and described. Accordingly, departures may be made from such details without departing from the spirit or scope of the general inventive concept.

What is claimed is:

1. A method for monitoring an online activity to be performed by a user of a user computer, the method comprising:
using a trigger program running on the user computer to detect possible violations by the user of predefined rules associated with the online activity, wherein the trigger program is configured to analyze one or more streams of data collected by the user computer during the activity;
automatically annotating the analyzed data to assist in determining whether a violation of the predefined rules occurred; and
storing on another computer a portion of the data collected by the user computer during the activity, wherein the stored data can be reviewed after the activity to assist in determining with whether a violation of the predefined rules occurred during the activity.

2. The method of claim 1 further comprising performing a check of the user computer configuration before the online activity begins.

3. The method of claim 1 wherein the online activity comprises taking an examination.

4. The method of claim 1 wherein the online activity comprises attending an online educational presentation.

5. The method of claim 1, wherein the one or more streams of data include at least one of a video clip acquired from a camera coupled to the user computer, a recording of the user computer's desktop, an audio clip, keystroke data, clipboard data and browsing history information captured by the user computer.

6. The method of claim 1 wherein the trigger program is activated in response to a predefined pattern of keystrokes made on the user computer.

7. The method of claim 1 wherein the trigger program is activated in response to data captured by a clipboard of the user's computer changing.

8. The method of claim 1 wherein the step of automatically prioritizing the analyzed data occurs before the step of storing the data collected by the user computer during the activity.

9. The method of claim 1 wherein the step of automatically prioritizing the analyzed data occurs after the step of storing the data collected by the user computer during the activity.

10. A method for monitoring an online examination to be taken by a student using a student computer, the method comprising:
receiving data associated with an online examination attempt,
wherein the received data has been captured using a trigger program running on the student computer for detecting possible violations by the student of predefined rules associated with the online examination,
wherein the trigger program is configured to analyze one or more streams of data collected by the student computer during the examination,
wherein the received data comprises a portion of the data collected and is automatically prioritized by the student computer during the examination; and
storing the received data in a storage medium for review after the examination for determining whether a violation of the predefined rules occurred during the examination.

11. The method of claim 10 further comprising performing a check of the student computer configuration before the examination begins.

12. The method of claim 10, wherein the one or more streams of data include at least one of a video clip acquired from a camera coupled to the student computer, a recording of the student computer's desktop, an audio clip, keystroke data, clipboard data and browsing history information captured by the student computer.

13. The method of claim 10 wherein the trigger program is activated in response to a predefined pattern of keystrokes made on the user computer.

14. The method of claim 10 wherein the trigger program is activated in response to data in a clipboard of the user computer being changed.

15. The method of claim 10 wherein the stored data is used to determine whether the student cheated on the examination.

16. The method of claim 10 wherein the received data is automatically prioritized for presentation on a timeline.

17. A system for reviewing a recording of an online examination that was attempted by a student, the system comprising:
a storage medium for storing data associated with an examination attempt, wherein the stored data is collected from a plurality of data streams using a trigger program running on a student computer for detecting possible violations by the student of predefined rules associated with the examination attempt; and
a proctor computer operative with the storage medium for presenting the stored data for review after the examination attempt for determining whether the student violated any of the predefined rules during the examination attempt;
wherein the trigger program is configured to analyze the plurality of data streams during the examination attempt and to automatically identify portions of the data as one or more incident to assist in determining whether the student violated any of the predefined rules during the examination attempt; and
wherein the stored data comprises a portion of the data collected from the plurality of data streams.

18. The system of claim 17 wherein the trigger program is activated in response to at least one of:
video information about the examination attempt;
facial recognition information about the student
audio information about the examination attempt;
keystroke information relating to the examination attempt; and
a browsing history of the student during the examination attempt.

19. The system of claim 17 further including means for a proctor can view the stored data, including skipping past portions of the data that is not identified as an incident.

20. The system of claim 17 further including means for a proctor to hide or display incidents based on data associated with the incident; and then skip past incidents that are hidden.
